(19) United States
(12) Patent Application Publication
(10) Pub. No.: US 2021/0360897 A1
(43) Pub. Date: Nov. 25, 2021

(54) WORKING CHUTE

(71) Applicant: Burlington Welding, LLC, Cherokee, OK (US)

(72) Inventor: Robert Leroy Wilson, Cherokee, OK (US)

(73) Assignee: Burlington Welding, LLC, Cherokee, OK (US)

(21) Appl. No.: 17/395,363

(22) Filed: Aug. 5, 2021

Related U.S. Application Data
(63) Continuation-in-part of application No. 15/667,688, filed on Aug. 3, 2017, now abandoned.
(60) Provisional application No. 62/370,555, filed on Aug. 3, 2016.

(51) Int. Cl. A01K 1/08; B60P 3/04; A01K 1/00

(52) U.S. Cl. CPC A01K 1/08; A01K 1/0035; B60P 3/04

(57) ABSTRACT

The Working Chute is comprised of a hydraulic gooseneck hitch; a torsion tube; a walking beam hydraulic lift; a walking beam axle; a main frame; alleyway escape gates; palpation gates; right and a left exit gates; two folding panels; outside panels; inside panels; a solar panel; a battery; and a hydraulic pump. The Working Chute can also be comprised of a dirt alleyway; a rubber floor; tires; a rolling tail gate; a drop in lock for extended panels; a chute panels parallel squeeze from both sides; a head gate squeezes from front; a section between tires for parallel squeeze; a hydraulic cylinder; a hitch; a hydraulic control for goose neck; a hydraulic control for rear lift; and a center point of walking axle which is a main pivot point. The Working Chute allows ranchers to access the livestock for palpation requirements such as marking, veterinary, or livestock care purposes. The Working Chute is both portable and that serves the various palpation needs of a livestock owner.

### CROSS-REFERENCE TO RELATED APPLICATIONS

Not Applicable.

### STATEMENT REGARDING FEDERALLY SPONSORED RESEARCH OR DEVELOPMENT

Not applicable

### BACKGROUND OF THE EMBODIMENTS

### Field of the Embodiments

The general field of the embodiments of the Working Chute are livestock equipment, particularly livestock chutes.

### Description of Prior Art

Ranchers and other owners of livestock commonly have a need for a may need to access the livestock for palpation requirements such as marking, veterinary, or livestock care purposes. Many times, this palpation access must take place in a remote location or a location without a permanent palpation corral. Building palpation corrals in such locations is prohibitively time consuming and expensive. Therefore, a palpation Working Chute that is both portable and that serves the various palpation needs of a livestock owner is of great value.

### SUMMARY OF THE EMBODIMENTS

Embodiments of the Embodiments of the Working Chute are comprised of a hydraulic gooseneck hitch; a torsion tube; a walking beam hydraulic lift; a walking beam axle; a main frame; alleyway escape gates; palpation gates; right and a left exit gates; two folding panels; outside panels; inside panels; a solar panel; a battery; and a hydraulic pump. The Working Chute can also be comprised of a dirt alleyway; a rubber floor; tires; a rolling tail gate; a drop in lock for extended panels; a chute panels parallel squeeze from both sides; a head gate squeezes from front; a section between tires for parallel squeeze; a hydraulic cylinder; a hitch; a hydraulic control for goose neck; a hydraulic control for rear lift; and a center point of walking axle which is a main pivot point.

In this respect, before explaining at least one embodiment of the embodiments in detail, it is to be understood that the embodiment is not limited in this application to the details of construction and to the arrangements of the components set forth in the following description or illustrated in the drawings. The embodiment or embodiments are capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be used as a basis for the designing of other structures, methods and systems for carrying out the several purposes of the embodiments. Additional benefits and advantages of the embodiments will become apparent in those skilled in the art to which the present embodiments relate from the subsequent description of the preferred embodiment and the appended claims, taken in conjunction with the accompanying drawings. It is important, therefore, that the claims be regarded as including such equivalent constructions insofar as they do not depart from the spirit and scope of the embodiments.

Further, the purpose of the foregoing abstract is to enable relevant patent granting authorities and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application which is measured by the claims, nor is it intended to be limiting as to the scope of the embodiments in any way.

### BRIEF DESCRIPTION OF THE DRAWINGS

FIG. 1 is a perspective view of an embodiment of the working chute with the gates closed and in a transportable configuration.

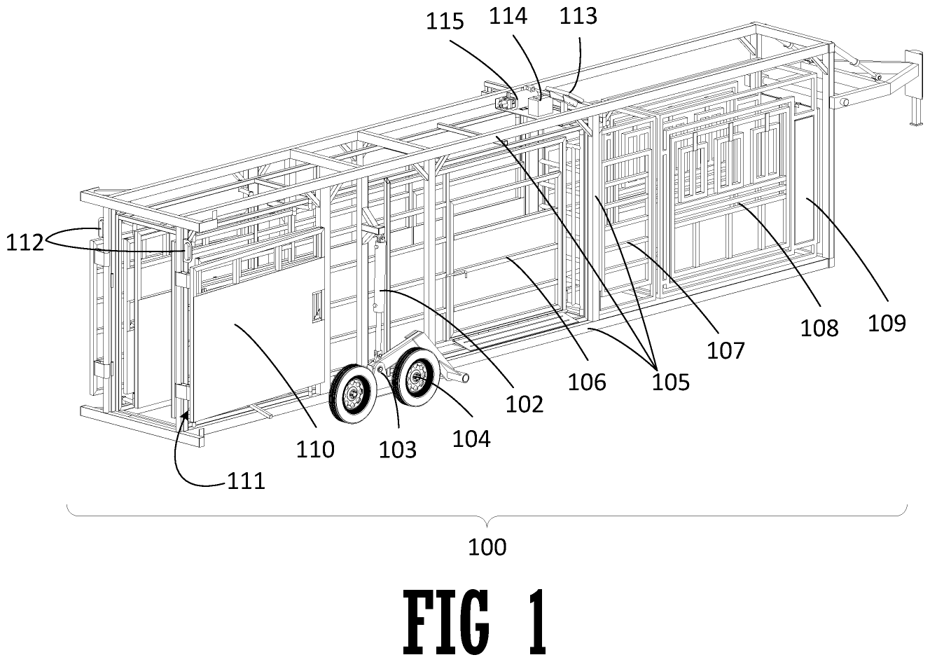

FIG. 2 is a perspective view of an embodiment of the working chute with the gates extended in a stationary position.

FIG. 3 is a perspective view of an embodiment of the working chute with the gates closed and in a transportable configuration.

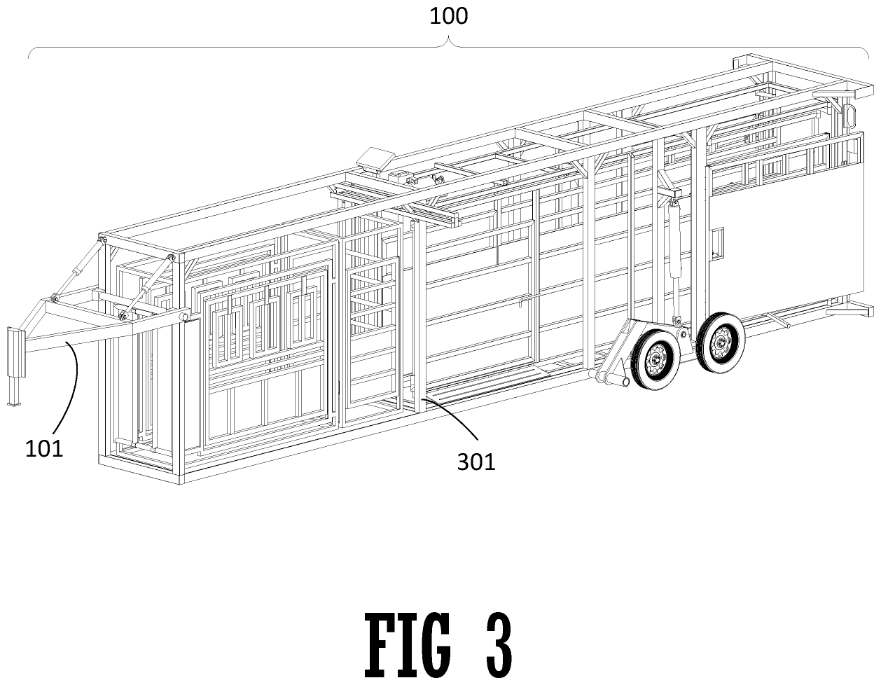

FIG. 4 is a perspective view of an embodiment of the working chute with the gates opened in a stationary position.

FIG. 5 is a side view of an embodiment of the working chute with the gates closed in a transportable configuration.

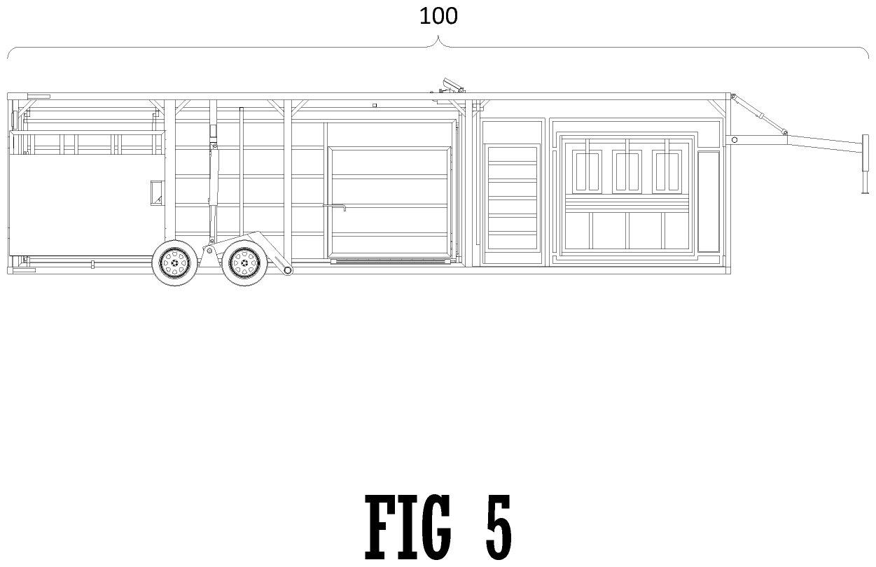

FIG. 6 is a side view of an embodiment of the working chute with the gates extended in a stationary position.

FIG. 7 is a top view of an embodiment of the working chute with the gates closed in a transportable configuration.

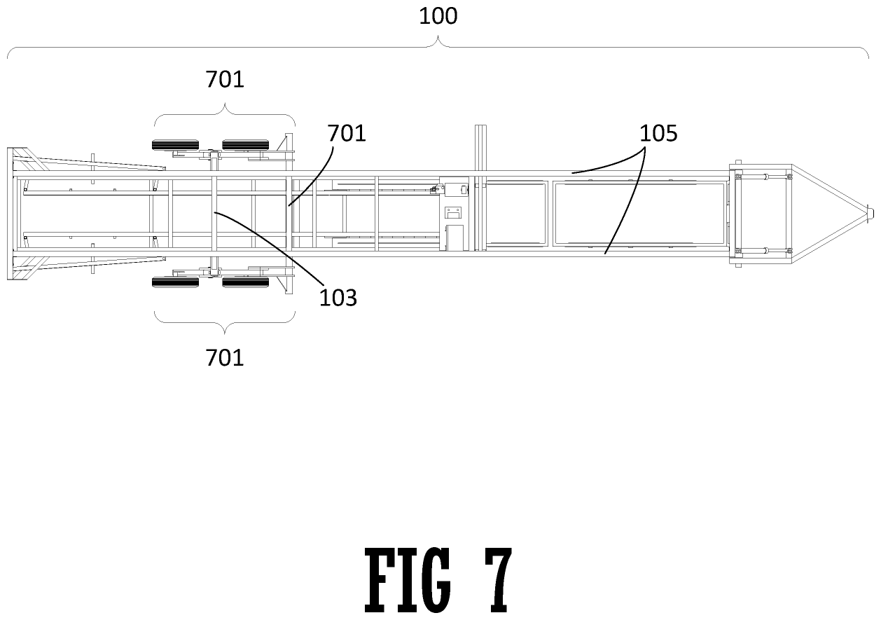

FIG. 8 is a top view of an embodiment of the working chute with the gates extended in a stationary position.

FIG. 9 is a perspective view of an embodiment of the working chute wheel assembly.

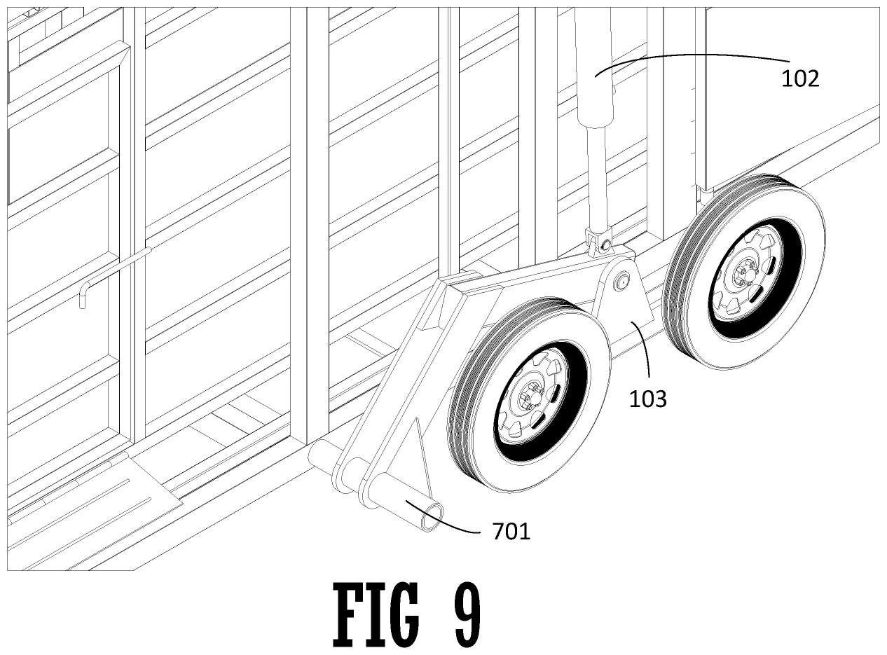

FIG. 10A is a side view of an embodiment of the working chute gooseneck hitch; FIG. 10B is a top view of an embodiment of the working chute gooseneck hitch.

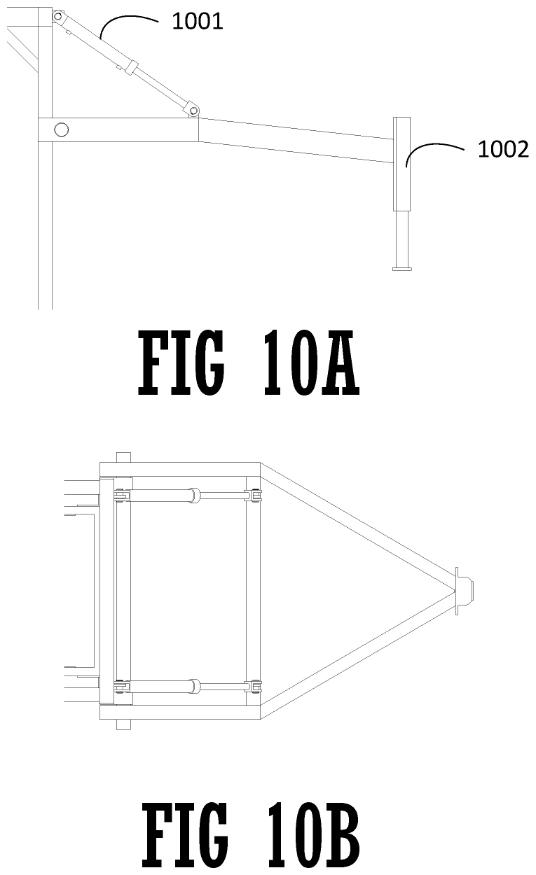

FIG. 11A is a side view of an embodiment of a single tire lift; FIG. 11B is a front view of an embodiment of a single tire lift.

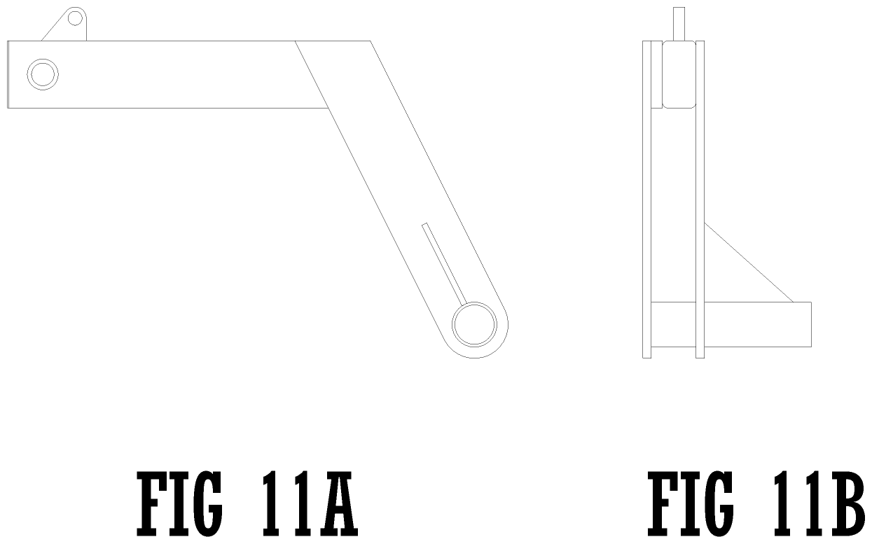

FIG. 12A is a back view of an embodiment of the working chute with the gates closed in a transportable configuration; FIG. 12B is a side view of an embodiment of the working chute with the gates closed in a transportable configuration

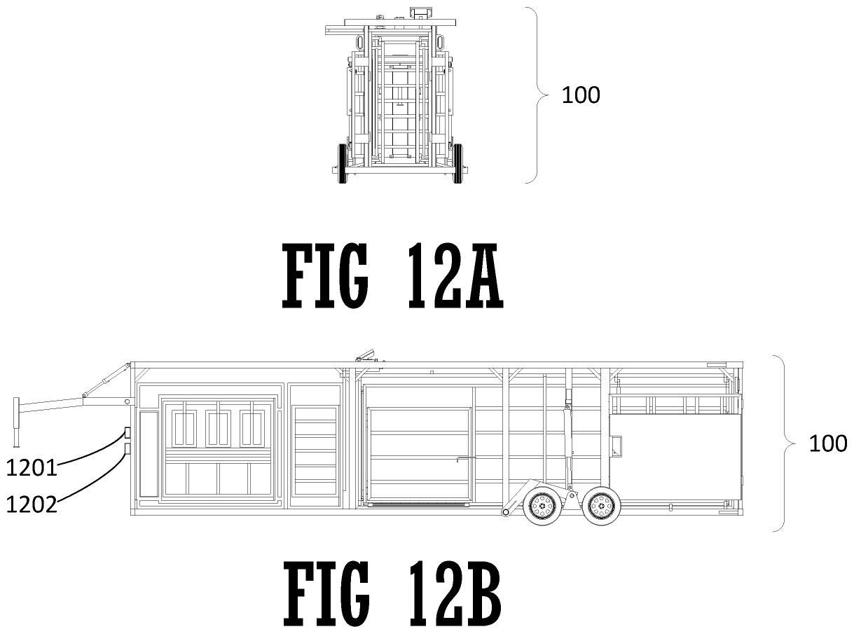

FIG. 13A is a top view of an embodiment of a rear axle bottom pivot point with the wheels removed; FIG. 13B is a side view of an embodiment of a rear axle bottom pivot point with the wheels removed.

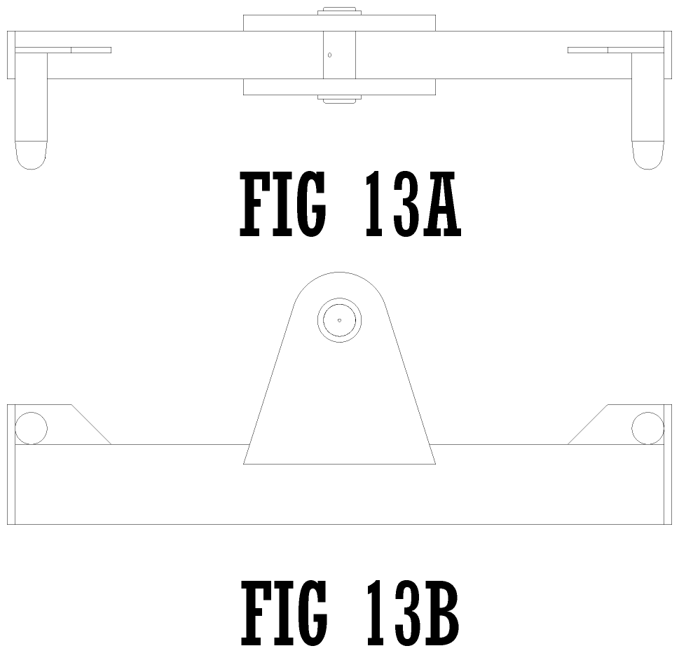

FIG. 14A is a top view of an embodiment of a wheel assembly showing a rear axle bottom pivot point with the wheels assembled; FIG. 14B is a side view of an embodiment of a rear axle bottom pivot point with the wheels assembled.

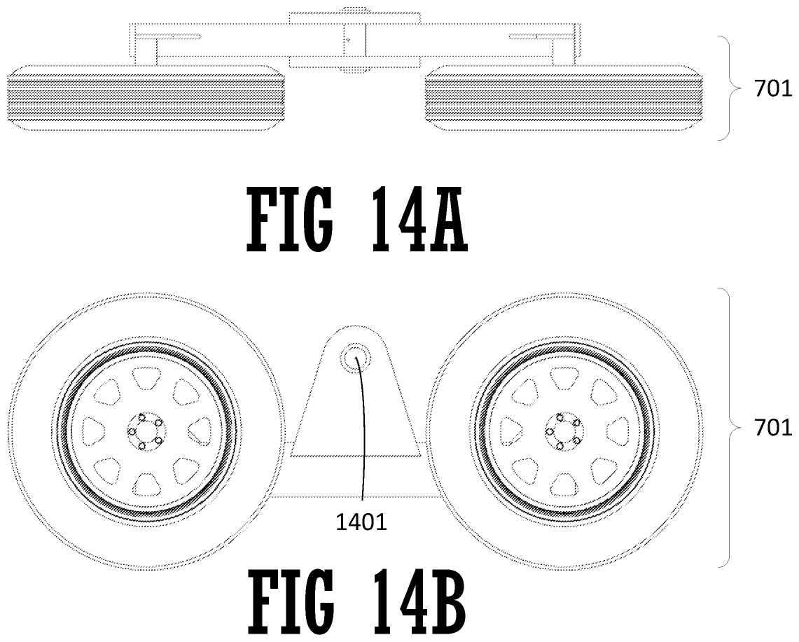

FIG. 15A is a side view of an embodiment of a hydraulic cylinder attachment to the rear of the Working Chute; FIG. 15B is a front view of an embodiment of a hydraulic cylinder attachment to the rear of the Working Chute.

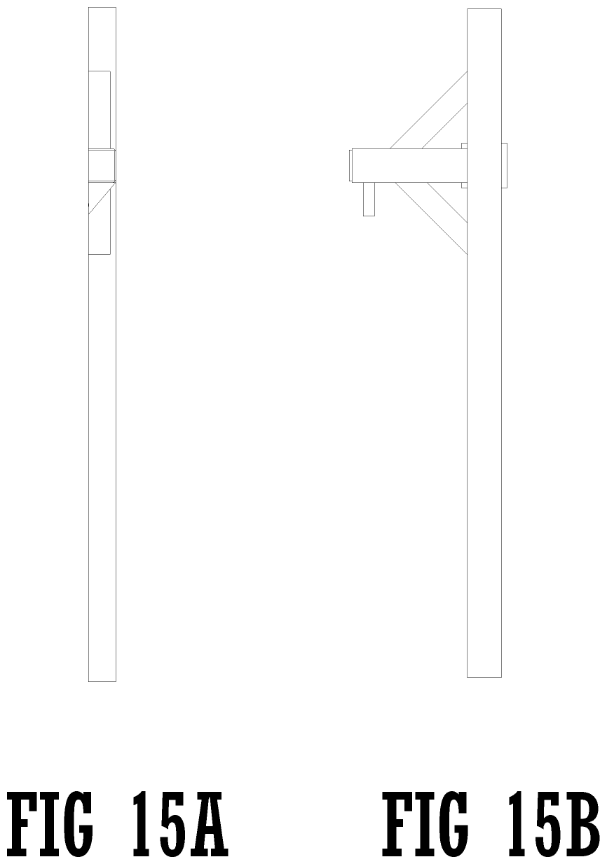

FIG. 16 is a side view of an embodiment of one 7 ft outside panel.

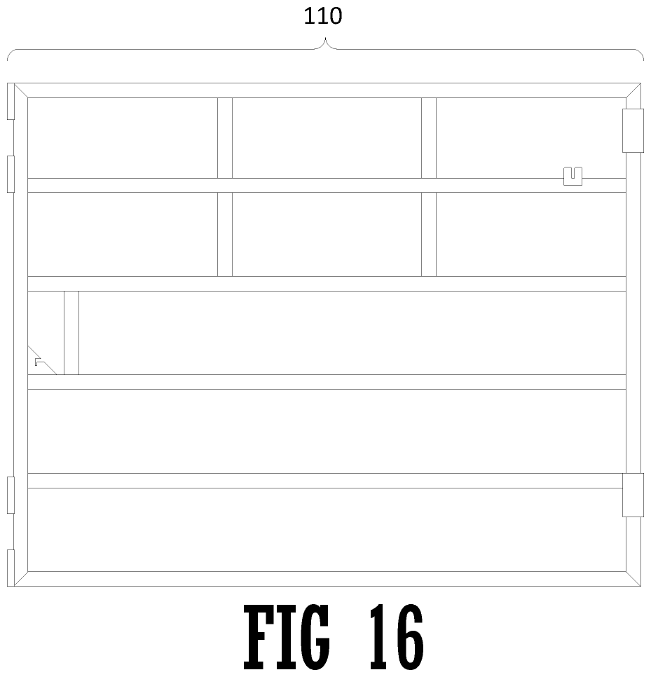

FIG. 17 is a side view of an embodiment of one 6 ft outside panel.

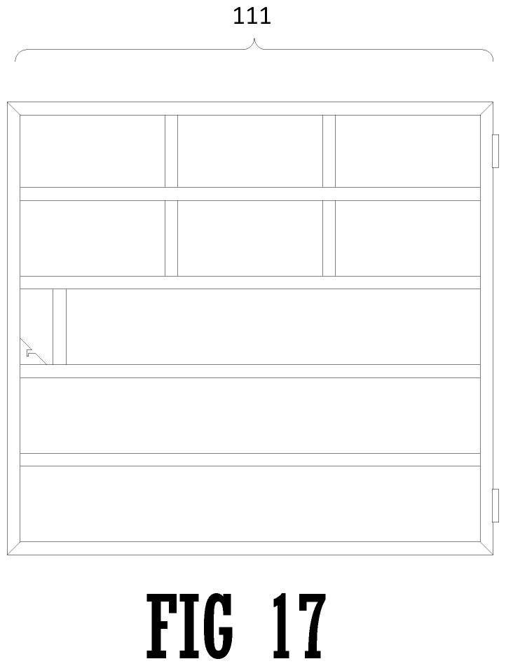

FIG. 18 is an end view of an embodiment of the main frame.

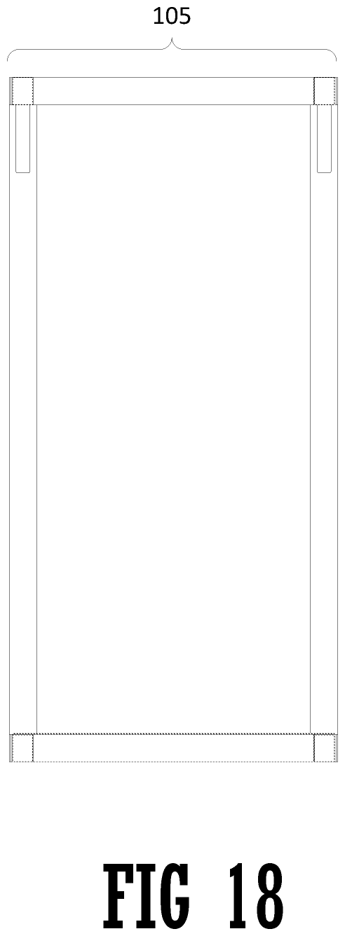

FIG. 19 is a top view of an embodiment of the wheel assembly.

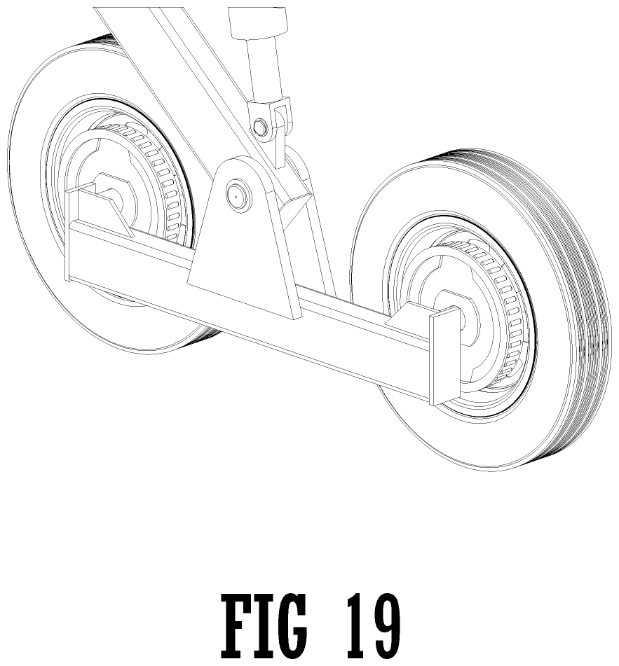

### DETAILED DESCRIPTION OF THE PREFERRED EMBODIMENTS

Embodiments of the Working Chute 100 are comprised one or more of the following: a hydraulic gooseneck hitch 101; a walking beam hydraulic lift 102; a walking beam axle 103; an electric brake 104; a main frame 105; two (2) alleyway escape gates 106 with one (1) escape gate on the right and one (1) escape gate on left of the working chute; two (2) palpation gates 107 with one (1) palpation gate on the right and one (1) palpation gate on left of the working chute; a right and a left exit gates 108; two folding panels for shots to neck 109; two outside panels 111 outside on both sides of the alleyway; two inside panels 110 outside on both sides of the alleyway; two taillights 112; a solar panel 113; a battery 114; a hydraulic pump 115; a dirt alleyway 201; a rubber floor 202; four (4) radial tires 203; a rolling tail gate 301; a drop in lock for extended panels 401; a torsion tube 701; a chute panels parallel squeeze from both sides 801; a head gate squeezes from front 802; an entry parallel squeeze 803; a hitch hydraulic cylinder 1001; a hitch 1002; a hydraulic control for goose neck 1201; a hydraulic control for rear lift 1202; and a center point 1401 of walking axle which is a main pivot point. In an embodiment of the Working Chute 100 the main frame 105 with is located along the entire length of the Working Chute 100 and supports all the components of the Working Chute 100 such components being welded to the main frame 105 via hinges or connecting joints. The center point 1401 of the walking axle connects the walking beam axle 103 to two wheel assemblies 701. Electric brakes 104 on at one wheel on both sides of the Working Chute, and preferably all wheels, help control the Working Chute 100 while being transported. In one preferred embodiment, the radial tires 203 are 235-16 radial tires.

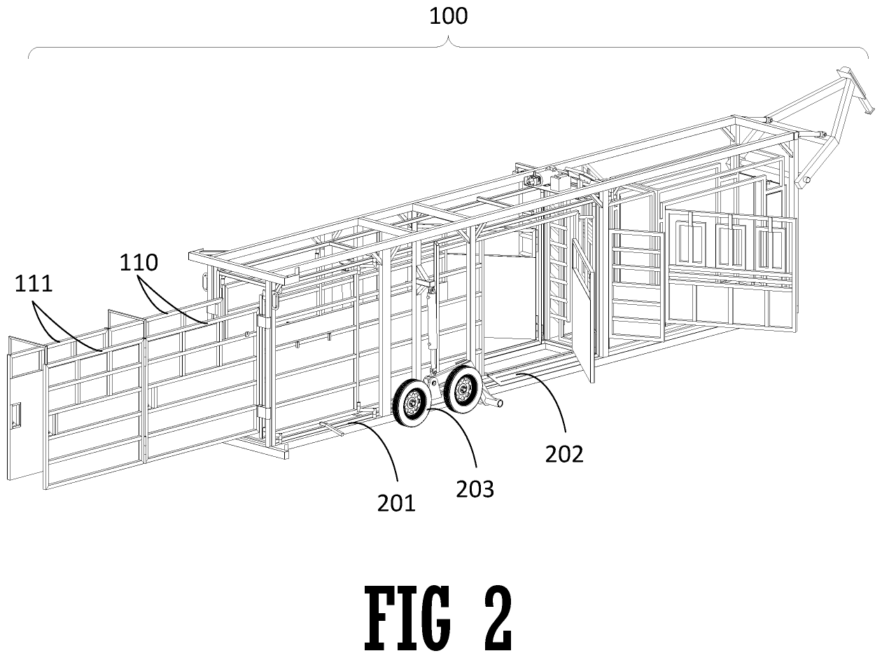

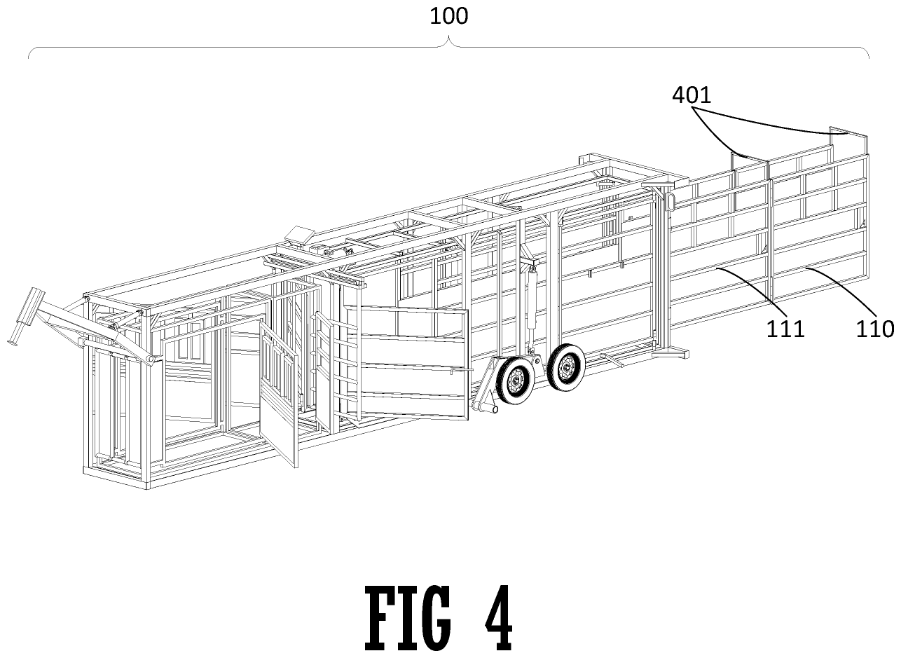

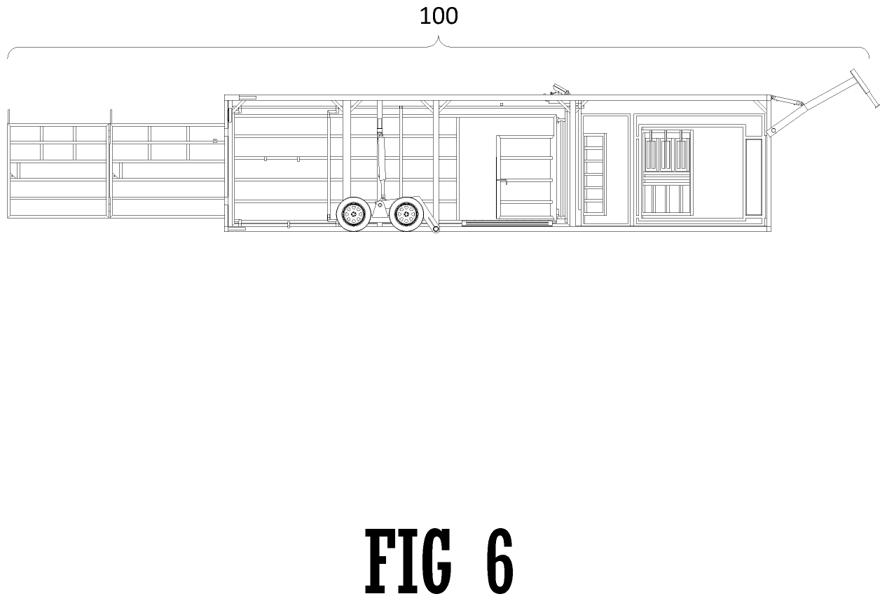

In an embodiment of the Working Chute 100 the two outside panels 111 outside on both sides of the alleyway and the two inside panels 110 outside on both sides of the alleyway extend rearward, as shown in FIGS. 2, 4, 6, 8, to form a channel into which livestock can be introduced to the Working Chute 100. The outside panels 111 and the inside panels 110 are collapsed telescopically into the Working Chute 100 for transportation.

In an embodiment of the Working Chute 100 the walking beam hydraulic lift 102 powered by the hydraulic pump 115 controlled by the hydraulic control for rear lift 1202. The walking beam axle 103 in the raised position (the walking beam axle is raised off the ground) permits the Working Chute 101 to be transported. The walking beam axle 103 in the lowered position (the walking beam axle on the ground) permits the Working Chute 101 to treat livestock.

In an embodiment of the Working Chute 100 the hydraulic gooseneck hitch 101 is powered by the hydraulic pump 115 and controlled by the hydraulic control for goose neck 1201.

In an embodiment of the Working Chute 100 the solar panel 113 supplies electrical power to the battery 114 which in turn supplies electrical power to the hydraulic pump 115. The hydraulic pump 115 supplies hydraulic power to the hitch hydraulic cylinder 1001 and the walking beam hydraulic lift 102.

In an embodiment of the Working Chute 100 the dirt alleyway 201 is formed, the two outside panels, 111 the two inside panels 110, and provides the channel for the livestock to move through the Working Chute 100.

Only a single operator is needed to raise and lower the walking beam axle 103 via the hydraulic control for rear lift 1202 and raise and lower the hydraulic gooseneck hitch 101 the hydraulic control for goose neck 1201. In addition, the Working Chute 100 can be towed by a commercially available ¾ ton pickup truck. The Working Chute 100 is fully self-contained and operable by a single individual.

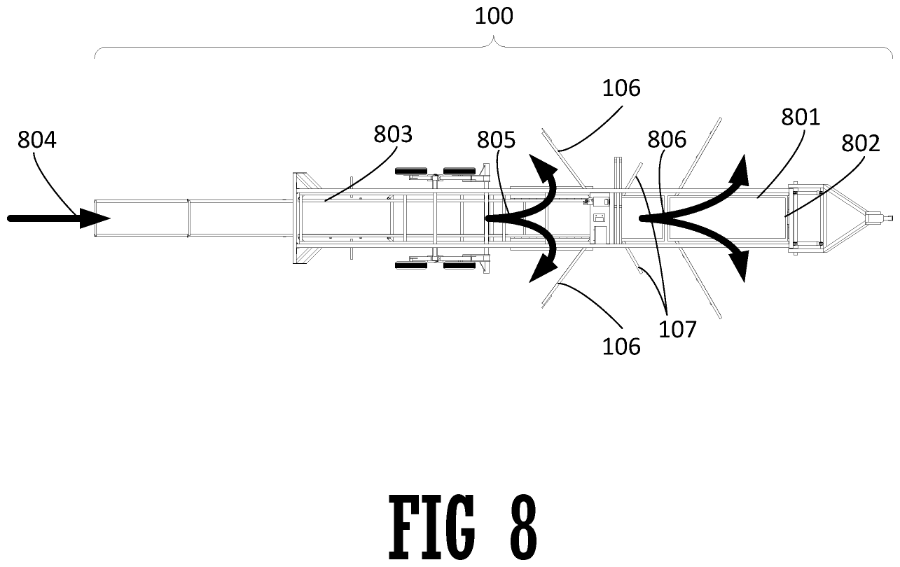

In an embodiment of the Working Chute 100 the alleyway escape gates 106, the palpation gates 107, the exit gates 108, the two folding panels for shots to neck 109 serve to treat the livestock while the livestock are contained in the Working Chute 100. As the livestock move forward into the Working Chute through the dirt alleyway 201, as shown in FIG. 8, the livestock are moved in an orderly fashion to the palpation gates 107 and the two folding panels 109 allowing the livestock to be treated or injected as necessary.

The Working Chute 100 is used by directing livestock to enter the Working Chute 100 via path 804. The livestock are directed through the section between the tires 803 that squeeze from both sides retard the livestock forward travel. The livestock can be directed to exit by open one or both of the two alleyway escape gates 106. Alternatively, the livestock can be directed to the area closed off by the chute panels 801 that can parallel squeeze from both sides. In addition, the head gate 802 can squeezes from front of the livestock. The livestock can be accessed for physician and veterinary work via the two (2) palpation gates 107. The livestock can then be removed from the Working Chute via either of the right or left exit gates 801 or both exit gates.

In an embodiment of the Working Chute 100 the hydraulic cylinder 1001 is a 3″×16″ hydraulic cylinder.

In an embodiment of the Working Chute 100 the main frame 105 is comprised of three inch (3 in) by five inch (5 in) rectangle tubing with three sixteenth inch ( 3/16″) wall thickness.

In an embodiment of the Working Chute 100 the two outside panels 111 are seven feet (7 ft) wide.

In an embodiment of the Working Chute 100 the two inside panels 110 are six feet (6 ft) wide.

In an embodiment of the Working Chute 100 the hitch 1002 comprises a hitch with nine inch (9″) vertical travel, a two and fifteen sixteen inch (2 5/16″) ball, thirty eight inch (38″) pulling height, and a nine foot four inch (9 ft 4 in) working height.

In an embodiment of the Working Chute 100 the entry parallel squeeze 803 between the tires is twenty foot (20′) in length.

What I claim is:

1. A working livestock chute comprising:
a main frame;
a hydraulic gooseneck hitch;
a hitch hydraulic cylinder;
a hitch;
a walking beam hydraulic lift;
a walking beam axle;
a torsion tube;
two alleyway escape gates;
two palpation gates;
two folding panels for shots to neck of the livestock;
two outside panels;
two inside panels;
a solar panel;
a battery; and
a hydraulic pump.

2. The working livestock chute described in claim 1 comprising:
a hydraulic control for goose neck; and
a hydraulic control for rear lift.

3. The working livestock chute described in claim 1 comprising:
one or more electric brakes;
a dirt alleyway;
a rubber floor;
four radial tires;
a rolling tail gate;
a drop in lock for extended panels;
chute panels that parallel squeeze from both sides;
a head gate squeezes from front;
an entry parallel squeeze; and
a center point of walking axle which is a main pivot point.

4. The working livestock chute described in claim 2 comprising:
one or more electric brakes;
a dirt alleyway;
a rubber floor;
four radial tires;
a rolling tail gate;
a drop in lock for extended panels;
chute panels that parallel squeeze from both sides;
a head gate squeezes from front;
an entry parallel squeeze; and
a center point of walking axle which is a main pivot point.
